(19) United States
(12) Patent Application Publication
(10) Pub. No.: US 2008/0299894 A1
(43) Pub. Date: Dec. 4, 2008

(54) Mobile communication device

(75) Inventors: Yoshiyuki Natori, Tokyo (JP); Tomohisa Yamashita, Kanagawa-ken (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KABUSHIKI KAISHA TOSHIBA, Tokyo (JP)

(21) Appl. No.: 12/075,246

(22) Filed: Mar. 10, 2008

(30) Foreign Application Priority Data
Jun. 1, 2007 (JP) 2007-147110
Jun. 7, 2007 (JP) 2007-151311

(51) Int. Cl. H04H 40/18

(52) U.S. Cl. 455/3.06

(57) ABSTRACT

A mobile communication device configured to communicate by radio with a base station connected to a network is provided. The mobile communication device has a broadcast receiver configured to receive broadcasting, a monitor configured to monitor condition of receiving broadcasting and a controller connected to the broadcast receiver and the monitor. The controller is configured to perform a first process in the foreground, and configured to selectively perform a second process in the background in parallel with the first process. The second process includes a process of receiving broadcasting. The controller is configured to end the process of receiving broadcasting if the broadcast receiver receives broadcasting as the second process controlled by the controller and the monitor detects degradation of the condition of receiving broadcasting.

### CROSS REFERENCE TO RELATED APPLICATIONS

This application is based upon and claims the benefit of priority from the prior Japanese Patent Applications No. 2007-147110 filed on Jun. 1, 2007, and No. 2007-151311 filed on Jun. 7, 2007; the entire contents of which are incorporated herein by reference.

### BACKGROUND OF THE INVENTION

1. Field of the Invention

The present invention relates to a mobile communication device, and in particular a mobile communication device configured to receive broadcasting.

2. Description of the Related Art

Mobile communication devices such as mobile phones are recently equipped with a function of receiving digital terrestrial television broadcasting (DTTB) in addition to functions of sending and receiving e-mails, web-browsing and voice communication, as disclosed in Japanese Patent Publications of Unexamined Applications (Kokai), No. 2007-110444.

Being equipped with multiple functions, though, the mobile communication devices remarkably grow in power consumption. Thus, it is required to reduce power consumption of the mobile communication devices.

A mobile communication device configured to reproduce a television (TV) broadcast such as DTTB, e.g., may consume more battery power than usual while TV reproduction. The mobile communication device may consequently end up with insufficient time available for voice communication after TV reproduction for a couple of hours, as battery voltage decreases to around a lower limit value without being noticed by a user.

A mobile phone configured to display specific data on a display upon detecting residual battery power lower than a certain value is disclosed in Japanese Patent Publications of Unexamined Applications (Kokai), No. 2006-217258. More specifically, a user of the mobile phone of JP 2006-217258 who is aware of the displayed data may immediately take action such as replacing the battery.

As growing in power consumption, a mobile communication device equipped with multiple functions is required to reduce the power consumption. Particularly in a case where DTTB reception of such a mobile communication device is interrupted while sounds (and pictures) received from DTTB are being produced in the background, a user of the mobile communication device may possibly forget having activated DTTB reproduction as actually no sounds are produced before and after the interruption occurs.

Particularly in a case where the mobile communication device is supposed to produce sounds in the background (actually no sounds are being produced as DTTB reproduction has been interrupted) without displaying a picture on a display, the user may possibly forget that an application of DTTB reception is running and that the mobile communication device is consuming power for running the application.

As described above, the mobile communication device may consume much battery power without being noticed by the user while receiving a TV broadcast or reproducing a moving picture. In a case where the user wants to start a voice communication session, the mobile communication device may be unable to receive a call, let alone send a call due to little residual battery power.

### SUMMARY OF THE INVENTION

Accordingly, an object of the present invention is to provide a mobile communication device configured to reduce power consumption while using a function other than communication.

Another object of the present invention is to provide a mobile communication device configured to monitor residual battery power while receiving a TV broadcast or reproducing a moving picture so as to ordinarily assure residual battery power required for voice call processing.

To achieve the above object, according to one aspect of the present invention, a mobile communication device configured to communicate by radio with a base station connected to a network is provided. The mobile communication device has a broadcast receiver configured to receive broadcasting, a monitor configured to monitor condition of receiving broadcasting and a controller connected to the broadcast receiver and the monitor. The controller is configured to perform a first process in the foreground, and configured to selectively perform a second process in the background in parallel with the first process. The second process includes a process of receiving broadcasting. The controller is configured to end the process of receiving broadcasting if the broadcast receiver receives broadcasting as the second process controlled by the controller and the monitor detects degradation of the condition of receiving broadcasting.

### BRIEF DESCRIPTION OF THE DRAWINGS

FIG. 1 is a block diagram of a main portion of a mobile communication device of a first embodiment of the present invention.

FIG. 2 is a block diagram of portions of the mobile communication device of the first embodiment relating to a process of receiving DTTB.

FIG. 3 is a flow chart of a process of DTTB reception of the mobile communication device of the first embodiment.

FIG. 4 is a flow chart of another process of DTTB reception of the mobile communication device of the first embodiment.

FIG. 5 is a block diagram of a mobile communication device of a second embodiment of the present invention.

FIG. 6 is a flow chart of a process for determining minimum voice call time of the mobile communication device of the second embodiment.

FIG. 7 is an exemplary diagram to show a screen for fixing the minimum voice call time.

FIG. 8 is a flow chart of a process of DTTB reproduction of the mobile communication device of the second embodiment after the DTTB reproduction starts.

FIG. 9 is a flow chart of part of the process shown in FIG. 8 for determining possibility of the DTTB reproduction.

FIG. 10 is an exemplary diagram to show a reproduced picture after the DTTB reproduction starts.

FIG. 11 is a flow chart of another process of the DTTB reproduction of the mobile communication device of the second embodiment before an end of the DTTB reproduction.

FIG. 12 is an exemplary diagram to show a reproduced picture before an end of the DTTB reproduction.

### DETAILED DESCRIPTION OF THE INVENTION

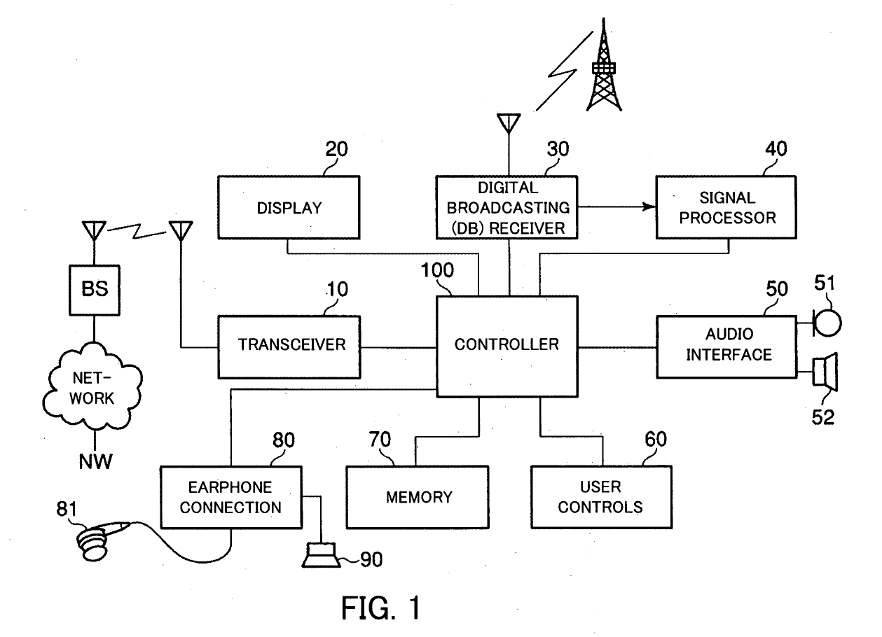

A first embodiment of the present invention will be described with reference to FIGS. 1-4. FIG. 1 is a block diagram of a main portion of a mobile communication device 1 of the first embodiment. The mobile communication device 1 includes, as shown in FIG. 1, a transceiver 10, a display 20, a digital broadcast (DB) receiver 30, a signal processor 40, an audio interface 50, user controls 60, a memory 70, an earphone connection 80, a speaker 90 and a controller 100.

The transceiver 10 is configured to perform wireless communication with a base station (BS) included in a network (NW) of a mobile phone system as instructed by the controller 100.

The display 20 has a liquid crystal display (LCD) and a backlight. The display 20 is configured to display pictures (static and moving) and text as instructed by the controller 100 so as to transfer information visually to a user of the mobile communication device 1. The display 20 is configured to backlight the LCD by turning on the backlight as instructed by the controller 100 so as to improve visibility of the information displayed on the LCD. The display 20 is configured to turn off the backlight as instructed by the controller 100.

The DB receiver 30 is configured to receive television (TV) broadcast waves such as, e.g., digital terrestrial TV broadcasting (DTTB) according to Integrated Services Digital Broadcasting-Terrestrial (ISDB-T) Standard. The DB receiver 30 is configured to provide the signal processor 40 with a received broadcast signal.

The signal processor 40 is configured to process the broadcast signal received by the DB receiver 30 so as to restore to video data and sound data, and to provide the controller 10 with the video data and the sound data.

The audio interface 50 includes a microphone 51 configured to convert outgoing voice of the user into an outgoing electrical signal, an encoder configured to encode the outgoing electrical signal into voice data, a decoder configured to decode incoming voice data received from another party of a voice call into an incoming electrical signal, and a speaker 52 configured to produce a sound represented by the incoming electrical signal.

The user controls 60 include plural keys and rotational switches for entering requests of the user.

The memory 70 is configured to store control programs and data of the controller 100, application software, a telephone directory associating names of people with their phone numbers, etc., data of sent or received emails, data downloaded from the Web through browsing, downloaded streaming or music data, moving picture data recorded from broadcast signals and so on. The above data may be stored in a memory card to be loaded in and unloaded out of a memory card slot (not shown).

The earphone connection 80 is an interface for connecting an earphone 81. If connected to the earphone 81, the earphone connection 80 may provide the earphone 81 with an audio signal provided by the controller 100 for producing a sound from the earphone 81. If disconnected from the earphone 81, the earphone connection 80 may provide the speaker 90 with the audio signal provided by the controller 100 for producing the sound.

Including a microprocessor device, the controller 100 is configured to operate according to the control programs and data stored in the memory 70 and to control each portion of the mobile communication device 1 comprehensively so as to perform voice communication and data communication. The controller 100 is configured to operate according to the application software stored in the memory 70. The controller 100 is configured to send and receive emails, to browse the Web, to display a moving picture on the display 20 on the basis of the downloaded streaming data, and to play music on the basis of the downloaded music data stored in the memory 70.

The controller 100 has a function of a clock to count date and time. The controller 100 has functions of controlling reception of a TV broadcast such as receiving a broadcast signal by controlling the DB receiver 30 and the signal processor 40, displaying a picture on the display 20 on the basis of the received broadcast signal, and producing a sound from the earphone 81 or the speaker 90.

The controller 100 has a multi-task control function to perform a plurality of the above functions simultaneously. By using the multitask control function, the controller 100 may perform functions of playing music data, receiving a TV broadcast and producing a sound of the TV in the background while performing functions of accepting an email to be sent, sending the email and browsing the Web in the foreground. A process in the foreground generally means a process according to operation performed on the user controls 60 while a related indication is displayed on the display 20. A process in the background generally means a process having no relation with operation performed on the user controls 60 while a related indication is displayed on the display 20. There are exceptions to the above general rule, however, such as a display process in the background accompanying a display process in the foreground, a process of accepting operation for transferring from the background to the foreground, or a process of accepting operation by using determined keys.

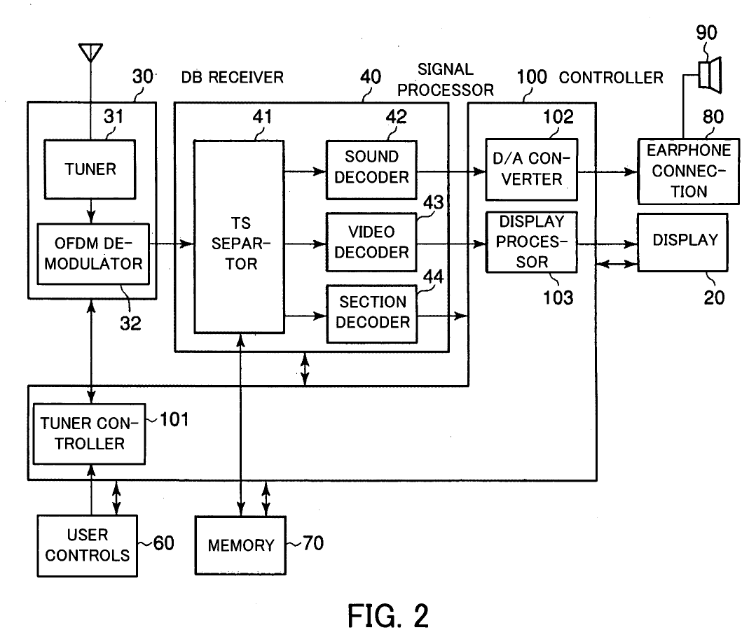

A detailed configuration of portions of the mobile communication device 1 relating to a process of receiving DTTB (called DTTB reception) will be described with reference to FIG. 2. Having accepted an instruction of a user to receive a TV broadcast through the user controls 60, the controller 100 may activate a tuner controller 101, a digital-to-analog (D/A) converter 102 and a display processor 103. The display processor 103 is configured to display a picture for channel selection and so forth on the display 20.

If the user controls 60 accept channel selection from the user, the tuner controller 101 instructs the DB receiver 30 to receive a TV broadcast wave of a channel selected by the user. The DB receiver 30 includes a tuner 31 and an orthogonal frequency division multiplexing (OFDM) demodulator 32. Receiving the TV broadcast wave of the instructed channel, the tuner 31 provides the OFDM demodulator 32 with a received OFDM signal.

The OFDM demodulator 32 may demodulate the received OFDM signal of the channel instructed by the tuner controller 101 so as to produce a transport stream. The transport stream may be divided into sound data, video data and an elementary stream such as section data by a transport stream (TS) separator 41 included in the signal processor 40.

The section data may be decoded into control data by a section decoder 44 included in the signal processor 40. The control data may be analyzed by the controller 100, used for control of TV broadcast waves or stored in the memory 70 as program information or various kinds of control information. The sound data may be decoded by a sound decoder 42 included in the signal processor 40, and converted into an analog sound signal by the D/A converter 102. The analog sound signal may be amplified by an amplifier (not shown) and provided to the earphone 81 or the speaker 90 through the earphone connection 80 so as to be produced as a sound. The video data, e.g., moving picture data compressed on the basis of the H.264 standard, may be expanded by a video decoder 43 included in the signal processor 40, and displayed as pictures on the display 20 by the display processor 103.

Having accepted a request for video recording or timer-reserved video recording, the controller 100 may record the sound data and the video data included in the received transport stream on the memory 70 as video recorded data. In a case of timer-reserved video recording, the controller 100 may detect a time reserved for video recording by using an own time counting function, and may activate each of the portions necessary for TV reception so as to record a program on a specified channel.

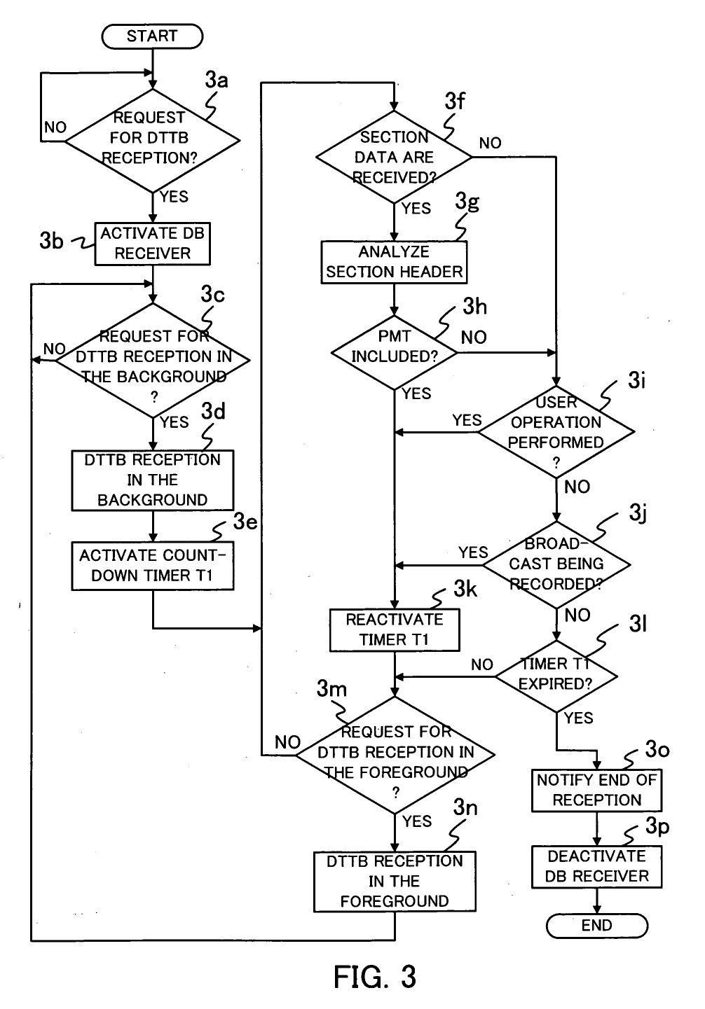

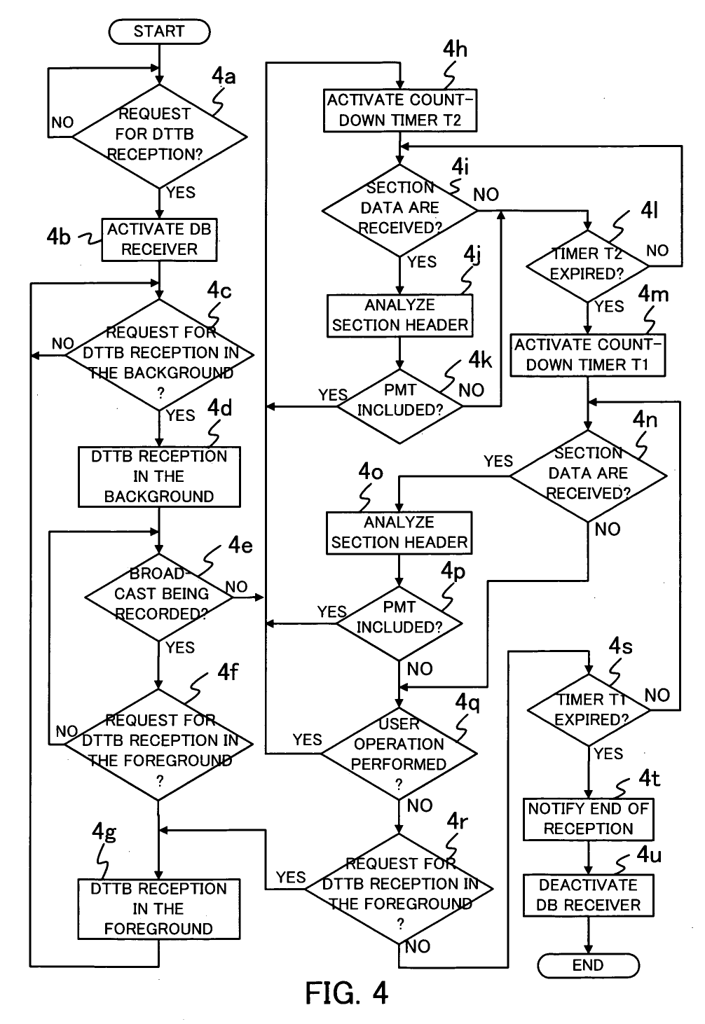

Operation of the mobile communication device 1 configured as described above will be explained hereafter. In particular, a process of receiving DTTB (called DTTB reception) will be explained as one of multiple tasks of the present invention as follows. Each of FIGS. 3-4 is a flow chart of the DTTB reception controlled by the controller 100.

The process shown in one of the above drawings may be performed repetitively while the mobile communication device 1 is being supplied with power between turned on and turned off, and the memory 70 stores a control program of the process. The controller 100 may perform various processes other than the processes shown in FIGS. 3-4 in parallel as necessary, and the memory 70 stores control programs of such processes.

The process performed in parallel may be sending and receiving emails, accepting input operation for writing emails, browsing the Web through packet communication or recording a broadcast which is being received in case of multi-task operation, let alone waiting for a call or email arrival.

The process shown in FIG. 3 will be explained at first. At a step 3a, the controller 100 determines if a request for reception of digital broadcasting (DTTB) is made by a user through the user controls 60. If the above request is made through the user controls 60, the controller 100 moves on to a step 3b. Otherwise, the controller 100 keeps monitoring occurrence of the above request at the step 3a.

At the step 3b, the controller 100 activates the DB receiver 30, the signal processor 40 and so on which are necessary for receiving the digital broadcasting, and then moves on to a step 3c. Having been activated thereby, each portion of the DB receiver 30, the signal processor 40 and so on which are necessary for the DTTB reception starts the DTTB reception.

After the step 3b, then, the TS separator 41 divides the transport stream produced by the OFDM demodulator 32 into sound data, video data and an elementary stream such as section data. Having been provided with the section data by the TS separator 41, the section decoder 44 decodes the section data so as to provide the controller 100 with decoded section data.

At the step 3c, the controller 100 determines if a request for the DTTB reception in the background is made by the user through the user controls 60. If the above request is made through the user controls 60, the controller 100 moves on to a step 3d. Otherwise, the controller 100 keeps monitoring occurrence of the above request at the step 3c.

At the step 3d, the controller 100 performs the DTTB reception in the background, and then moves on to a step 3e. Performing the DTTB reception in the background means a process for enabling the user only to listen to a broadcast sound while performing another process such as writing an email in the foreground. That is, the controller 100 performs a process other than the DTTB reception in the foreground.

Thus, in a case where the DTTB reception is performed in the background, the D/A converter 102 converts a digital sound signal produced by the sound decoder 42 into an analog sound signal which is provided to the earphone 81 or the speaker 90 through the earphone connection 80 so as to be produced as a sound.

Meanwhile, the video decoder 43 does not decode the video data. The display processor 103 does not control presentation of broadcasted pictures, but displays a picture relating to the process performed in the foreground or a picture of a home screen.

At the step 3e, the controller 100 activates a countdown timer T1 so as to start countdown of a preset period of time (e.g., 600 seconds), and then moves on to a step 3f.

At the step 3f, the controller 100 determines if the section data are received or not depending on if control data based on the section data are entered from the section decoder 44 or not. If the control data are entered and the section data are received, the controller 100 moves on to a step 3g. Otherwise, the controller 100 moves on to a step 3i.

At the step 3g, the controller 100 analyzes a section header of the control data provided by the section decoder 44, and then moves on to a step 3h.

At the step 3h, the controller 100 determines if the section header includes a program map table (PMT). If the PMT is included, the controller 100 moves on to a step 3k. Otherwise, the controller 100 moves on to the step 3i. The PMT is a PID of a TS packet which transfers each of encoded signals forming a program, and is sent from a transmitting station at an interval no greater than 500 milliseconds.

At the step 3i, the controller 100 determines if user operation of a DTTB application being activated in the background (exceptional operation of a background process) is performed by monitoring operation performed on the user controls 60. If, e.g., user operation is performed for an email application (a process of writing emails) which is running in the foreground, the controller 100 does not determine that user operation is performed at the step 3i. It may be determined that no operation is performed in a case where just no user operation (which may include operation of a foreground process) is performed in a preset period of time since receiving condition is degraded.

If the user operation is performed, the controller 100 moves on to a step 3k. Otherwise, the controller 100 moves on to a step 3j. The user operation monitored at the step 3i may be limited to operation relating to the DTTB reception, such as a received channel change and a change of loudness control. Operation of the DTTB reception in the background which has been determined at the step 3c may be regarded as a kind of the user operation at the step 3i.

At the step 3j, the controller 100 determines if the received broadcast is being recorded, i.e., if the received video data and sound data are being recorded in the memory 70. If the broadcast is being recorded, the controller 100 moves on to a step 3k. Otherwise, the controller 100 moves on to a step 3l.

At the step 3k, the controller 100 reactivates the countdown timer T1, i.e., restarts the countdown from a beginning, and moves on to a step 3m.

At the step 3l, the controller 100 determines if the countdown of the countdown timer T1 started at the step 3i or 3k has expired, i.e., if the preset period of time (e.g., 600 seconds) has passed since the beginning of the countdown started at the step 3e or 3k. If the preset period of time has passed, the controller 100 moves on to a step 3o. Otherwise, the controller 100 moves on to the step 3m.

At the step 3m, the controller 100 determines if a request for the DTTB reception in the foreground is made by the user through the user controls 60. If the above request is made through the user controls 60, the controller 100 moves on to a step 3n. Otherwise, the controller 100 moves on to the step 3f.

At the step 3n, the controller 100 performs the DTTB reception in the foreground, and then moves on to the step 3c. Performing the DTTB reception in the foreground means a process for enabling the user to usually view and listen to the broadcast.

Thus, in a case where the DTTB reception is performed in the foreground, the D/A converter 102 converts a digital sound signal produced by the sound decoder 42 into an analog sound signal which is provided to the earphone 81 or the speaker 90 through the earphone connection 80 so as to be produced as a sound.

Meanwhile, the video decoder 43 decodes the video data, and the display processor 103 controls presentation of pictures to the user on the basis of a decoded output.

At the step 3o, the controller 100 presents a pop-up message overlaid on a picture that has already been displayed, and moves on to a step 3p. At the step 3p, the controller 100 deactivates the DB receiver 30, the signal processor 40 and so on so as to stop the DTTB reception and to end the process.

Next, the process shown in FIG. 4 will be explained. At a step 4a, the controller 100 determines if a request for DTTB reception is made by a user through the user controls 60. If the above request is made through the user controls 60, the controller 100 moves on to a step 4b. Otherwise, the controller 100 keeps monitoring occurrence of the above request at the step 4a.

At the step 4b, the controller 100 activates the DB receiver 30, the signal processor 40 and so on which are necessary for the DTTB reception, and then moves on to a step 4c. Having been activated thereby, each portion of the DB receiver 30, the signal processor 40 and so on which are necessary for the DTTB reception starts the DTTB reception.

After the step 4b, then, the TS separator 41 divides the transport stream produced by the OFDM demodulator 32 into sound data, video data and an elementary stream such as section data. Having been provided with the section data by the TS separator 41, the section decoder 44 decodes the section data so as to provide the controller 100 with decoded section data.

At the step 4c, the controller 100 determines if a request for the DTTB reception in the background is made by the user through the user controls 60. If the above request is made through the user controls 60, the controller 100 moves on to a step 4d. Otherwise, the controller 100 keeps monitoring occurrence of the above request at the step 4c.

At the step 4d, the controller 100 performs the DTTB reception in the background, and then moves on to a step 4e. Performing the DTTB reception in the background means a process for enabling the user only to listen to broadcast sounds while performing another process such as writing an email in the foreground. That is, the controller 100 performs a process other than the DTTB reception in the foreground.

Thus, in a case where the DTTB reception is performed in the background, the D/A converter 102 converts a digital sound signal produced by the sound decoder 42 into an analog sound signal which is provided to the earphone 81 or the speaker 90 through the earphone connection 80 so as to be produced as a sound.

Meanwhile, the video decoder 43 does not decode video data. The display processor 103 does not control presentation of broadcasted pictures, but displays a picture relating to the process performed in the foreground or a picture of a home screen.

At the step 4e, the controller 100 determines if the received broadcast is being recorded, i.e., if the received video data and sound data are being recorded in the memory 70. If the broadcast is being recorded, the controller 100 moves on to a step 4f. Otherwise, the controller 100 moves on to a step 4h.

At the step 4f, the controller 100 determines if a request for the DTTB reception in the foreground is made by the user through the user controls 60. If the above request is made through the user controls 60, the controller 100 moves on to a step 4g. Otherwise, the controller 100 moves on to the step 4e.

At the step 4g, the controller 100 performs the DTTB reception in the foreground, and then moves on to the step 4c. Performing the DTTB reception in the foreground means a process for enabling the user to usually view and listen to the broadcast.

Thus, in a case where the DTTB reception is performed in the foreground, the D/A converter 102 converts a digital sound signal produced by the sound decoder 42 into an analog sound signal which is provided to the earphone 81 or the speaker 90 through the earphone connection 80 so as to be produced as a sound.

At the step 4h, the controller 100 activates a countdown timer T2 so as to start countdown of a preset period of time (e.g., 500 milliseconds), and then moves on to a step 4i.

At the step 4i, the controller 100 determines if the section data are received or not depending on if control data based on the section data are entered from the section decoder 44 or not. If the control data are entered and the section data are received, the controller 100 moves on to a step 4j. Otherwise, the controller 100 moves on to a step 4l.

At the step 4j, the controller 100 analyzes a section header of the control data provided by the section decoder 44, and then moves on to a step 4k.

At the step 4k, the controller 100 determines if the section header includes a program map table (PMT). If the PMT is included, the controller 100 moves on to the step 4h. Otherwise, the controller 100 moves on to the step 4l. The PMT is a PID of a TS packet which transfers each of encoded signals forming a program, and is sent from a transmitting station at an interval no greater than 500 milliseconds.

At the step 4l, the controller 100 determines if the countdown of the countdown timer T2 started at the step 3e or 3k has expired, i.e., if the preset period of time (e.g., 500 milliseconds) has passed since the beginning of the countdown started at the step 4h. If the preset period of time has passed, the controller 100 moves on to a step 4m. Otherwise, the controller 100 moves on to the step 4i.

At the step 4m, the controller 100 activates the countdown timer T1 so as to start countdown of a preset period of time (e.g., 600 seconds), and then moves on to a step 4n.

At the step 4n, the controller 100 determines if the section data are received or not depending on if control data based on the section data are entered from the section decoder 44 or not. If the control data are entered and the section data are received, the controller 100 moves on to a step 4o. Otherwise, the controller 100 moves on to a step 4q.

At the step 4o, the controller 100 analyzes a section header of the control data provided by the section decoder 44, and then moves on to a step 4p.

At the step 4p, the controller 100 determines if the section header includes a PMT. If the PMT is included, the controller 100 moves on to the step 4h. Otherwise, the controller 100 moves on to a step 4q.

At the step 4q, the controller 100 determines if user operation of a digital broadcast application being processed in the background is performed by monitoring operation performed on the user controls 60, i.e., if the user operates to ask, e.g., a received channel change or a change of loudness control.

If such user operation is performed, the controller 100 moves on to the step 4h. Otherwise, the controller 100 moves on to a step 4r. The user operation to be monitored above may not be limited to operation in the background, but may be operation in the foreground such as writing an email. It may be determined that no operation is performed in a case where no user operation is performed in a preset period of time since receiving condition is degraded.

At the step 4r, the controller 100 determines if a request for the DTTB reception in the foreground is made by the user through the user controls 60. If the above request is made through the user controls 60, the controller 100 moves on to the step 4q. Otherwise, the controller 100 moves on to a step 4s.

At the step 4s, the controller 100 determines if the countdown of the countdown timer T1 started at the step 3m has expired, i.e., if the preset period of time (e.g., 600 seconds) has passed since the beginning of the countdown started at the step 4m. If the preset period of time has passed, the controller 100 moves on to a step 4t. Otherwise, the controller 100 moves on to the step 4n.

At the step 4t, the controller 100 presents a pop-up message overlaid on a picture that has already been displayed, and moves on to a step 4u. At the step 4u, the controller 100 deactivates the DB receiver 30, the signal processor 40 and so on so as to end the DTTB reception and to end the process.

The mobile communication device 1 configured to work according to FIGS. 3-4 as described above deactivates the DB receiver 30 and the signal processor 40 while the DTTB reception in the background in such degraded receiving condition that the PMT may not be received for a determined period of time, and ends the DTTB reception thereby.

If the mobile communication device 1 stops producing sounds in degraded receiving condition of DTTB, the user may possibly forget that the DB receiver 30 and the signal processor 40 which are necessary for the DTTB reception are being activated. And yet, the mobile communication device 1 deactivates the DB receiver 30 and the signal processor 40 so as to end the DTTB reception if, as described above, the degraded receiving condition continues for the determined period of time.

Thus, even if the user forgets that the DTTB reception continues in the background in degraded receiving condition, the mobile communication device 1 may end the DTTB reception and may save battery power thereby.

Besides, if user operation is performed or the broadcast is being recorded even in degraded condition of the DTTB reception in the background, the mobile communication device 1 does not end the DTTB reception by reactivating the countdown timer. In a case where the user is probably by the mobile communication device 1 or the program is being recorded, the mobile communication device 1 continues the DTTB reception.

The present invention is not limited to the first embodiment described above, but may be variously modified within a scope of the present invention. The portions of the first embodiment disclosed above may be appropriately combined so as to form various aspects of the present invention. In addition, one of the portions may be conceivably omitted. Further, portions of different embodiments may be appropriately combined.

For instance, although being determined to be degraded if the PMT that should be periodically sent is not received for a determined period of time or more, the receiving condition may be determined by using another method.

For instance, although the mobile communication device 1 of the first embodiment may be a mobile phone, the present invention may be applied to a personal computer or a personal digital assistant (PDA) configured to receive digital broadcasting in the background.

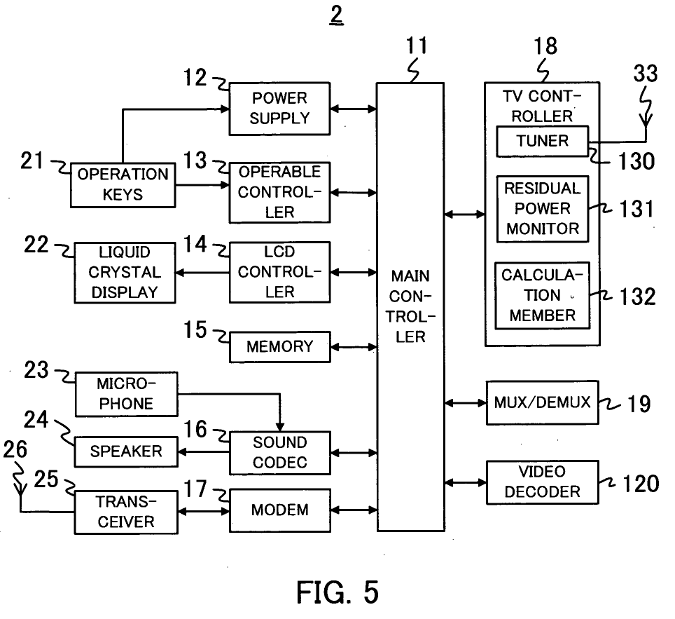

A second embodiment of the present invention will be described with reference to FIGS. 5-12. FIG. 5 is a block diagram of a mobile phone 2 of the second embodiment configured to receive a signal of a moving picture of DTTB (including a DTTB service using one segment out of 13 segments of each channel, called “1seg”) and to produce a moving picture.

As shown in FIG. 5, the mobile phone 2 has a main controller 11, a power supply 12, an operable controller 13, a liquid crystal display controller (LCD controller) 14, a memory 15, a sound codec 16, a modem 17, a television controller (TV controller) 18, a multiplexer/demultiplexer (MUX/DEMUX) 19 and a video decoder 120.

The main controller 11 includes a central processing unit (CPU) capable of performing various data processing and logical operations. The main controller 11 is configured to comprehensively control the mobile phone 2, to monitor residual battery power as described later and to perform various logical or control operations. The power supply 12 is configured to switch power on and off on the basis of input operation performed on a plurality of operation keys 21 by the user. If the power is switched on, a power source (such as a battery) supplies each portion of the mobile phone 2 with power so that the mobile phone 2 is activated. The power supply 12 controls the residual battery power of the power source and sends data of a value of the residual battery power on request.

The operable controller 13 is configured to provide the main controller 11 with data entered through the operation keys 21. The LCD controller 14 is configured to display text data and video data on a liquid crystal display 22 as controlled by the main controller 11. The memory 15 includes a read only memory (ROM) configured to store a program to be processed by the main controller 11, a magnetic storage device such as a hard disk, and an electric storage device such as a random access memory (RAM) configured to temporarily store data used by the main controller 11 for processing.

The sound codec 16 is configured to produce an analog voice signal from a voice picked up by a microphone 23 as controlled by the main controller 11. For voice communication, the sound codec 16 provides the modem 17 with the analog voice signal, and the modem 17 converts the analog voice signal to a digital voice signal which is provided to a transceiver 25. The transceiver 25 transmits the digital voice signal through an antenna 26.

The modem 17 is configured to convert a digital voice signal received through the transceiver 25 to an analog voice signal. For voice communication, the sound codec 16 is provided with the analog voice signal by the modem 17, and produces a voice from a speaker 24.

The TV controller 18 includes a tuner 130 configured to receive a moving picture signal of DTTB (including 1seg), a residual power monitor 131, and a calculation member 132 configured to calculate remaining time for reproducing a DTTB program (called DTTB reproduction) on the basis of the residual battery power of the mobile phone 2.

The MUX/DEMUX 19 is configured to perform multiplexing, i.e., to multiplex a plurality of signals so as to produce a multiplexed signal. The MUX/DEMUX 19 is configured to perform demultiplexing, i.e., to divide a multiplexed signal into a plurality of signals. For instance, the MUX/DEMUX 19 is provided with a multiplexed moving picture signal of DTTB received by the TV controller 18. Dividing the moving picture signal into a picture signal and a sound signal, the MUX/DEMUX 19 provides the video decoder 120 and the sound codec 16 with the picture signal and the sound signal, respectively.

Being provided with the picture signal by the MUX/DEMUX 19, the video decoder 120 decodes the picture signal by using a decoding method according to a determined coding method so as to produce a moving picture signal to be reproduced. Being provided with the moving picture signal to be reproduced by the video decoder 120, the LCD controller 14 may display a moving picture of DTTB on the liquid crystal display panel 22.

The program for being processed by the main controller 11 may be installed in the memory 15 in advance, or may be downloaded through an antenna 26.

While receiving a moving picture signal of DTTB and reproducing a moving picture, a mobile phone capable of reproducing TV broadcasting may possibly run out of battery power without being noticed by a user. On this occasion, the mobile phone may become unable to send and receive a voice call or an email. Thus, the mobile phone 2 of the present invention is configured to monitor residual battery power before receiving a moving picture signal of DTTB and reproducing a moving picture so as to assure minimum residual power necessary for communication use.

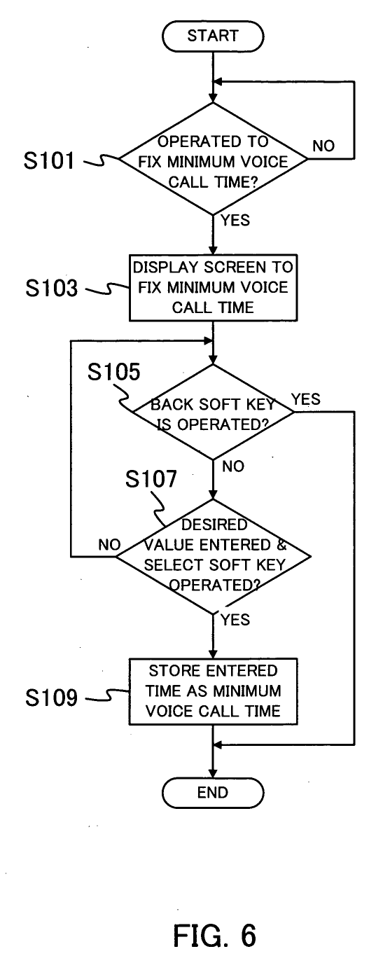

The mobile phone 2 is configured to monitor the residual battery power so that a present value of the residual battery power remains no less than a regular value of the residual battery power. The regular value of the residual battery power is stored in the memory in advance. The mobile phone 2 is configured to monitor the residual battery power so as to assure battery power required for a fixed period of time assigned to voice communication use. The fixed period of time may be determined as minimum voice call time according to, e.g., a flow chart shown in FIG. 6 and stored in the memory 15.

A process for determining the minimum voice call time of the mobile phone 2 will be described with reference to FIG. 6. A term designating each of steps shown in FIG. 6 and so on should simply be denoted as “SXXX”, e.g., “S101” instead of “step S101”.

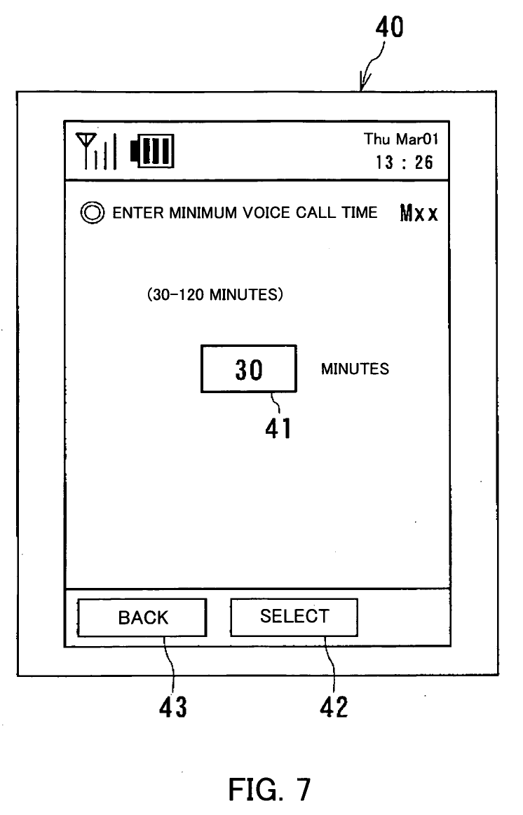

At first, the main controller 11 determines if a user has operated through the operation keys 21 so as to fix the minimum voice call time (S101). If the user has operated so as to fix the minimum voice call time, the main controller 11 displays on the liquid crystal display 22 a screen 40 to fix the minimum voice call time as shown in FIG. 7 (S103). On the screen 40, shown are an entry box 41 for entering the minimum voice call time, a select soft key 42 to fix the minimum voice call time according to time entered in the entry box 41, and a back soft key 43 to end the process without fixing the minimum voice call time. The user may enter a desired value of the minimum voice call time in the entry box 41 by using the operation keys 21.

The main controller 11 determines if the back soft key is operated (S105). If the back soft key is operated (“YES” of S105), the main controller 11 ends the process without fixing the minimum voice call time. Otherwise (“NO” of S105), the main controller 11 determines if the desired value of the minimum voice call time has been entered and the select soft key is operated (S107). Unless the desired value has been entered and the select soft key is operated (“NO” of S107), the main controller 11 goes back to S105 and waits for the back soft key 43 or the select soft key 42 to be operated.

If the desired value has been entered and the select soft key is operated (“YES” of S107), the main controller 11 stores the value entered in the entry box 41 in the memory 15 as the minimum voice call time (S109). By dint of storing the entered value in the memory 15 as the minimum voice call time, the main controller 11 may define the minimum voice call time.

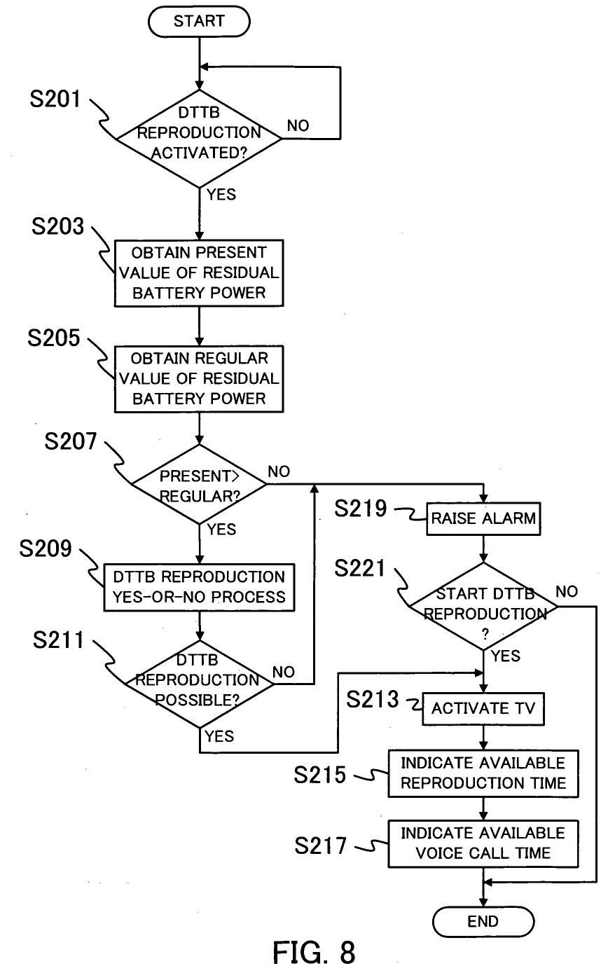

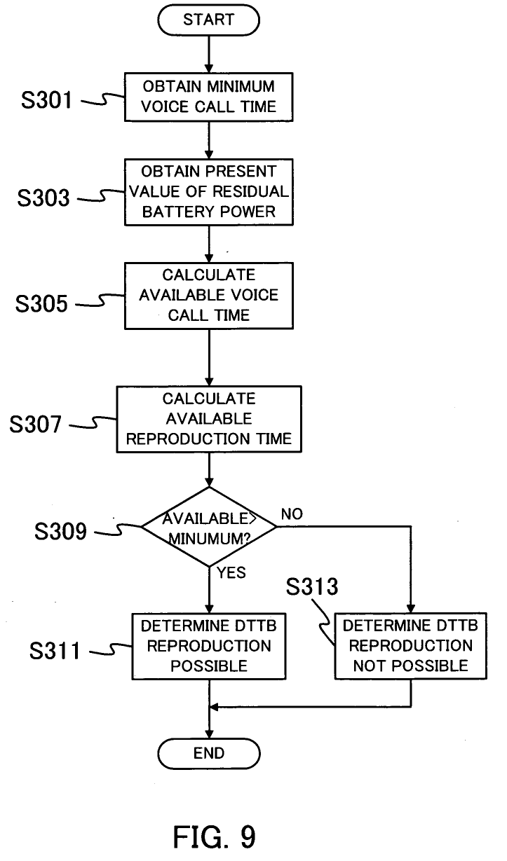

Next, a process of the mobile phone 2 for monitoring residual battery power while the DTTB reproduction according to the fixed minimum voice call time will be described with reference to flow charts shown in FIG. 8 and FIG. 9.

At first, the main controller 11 determines if a function of the DTTB reproduction of the mobile phone 2 has been activated (S201). If the function has been activated (“YES” of S201), the residual power monitor 131 obtains a present value of residual battery power from the power supply 12 (S203), and obtains the regular value of the residual battery power from the memory 15 (S205).

Comparing the present value of the residual battery power obtained at S203 with the regular value of the residual battery power obtained at S205, the residual power monitor 131 determines if the present value of the residual battery power exceeds the regular value of the residual battery power (S207).

If the present value of the residual battery power exceeds the regular value of the residual battery power (“YES” of S207), the residual power monitor 131 determines that the mobile phone 2 has residual battery power enough for the DTTB reproduction. Then, the calculation member 132 performs a process for determining if the DTTB reproduction is possible or not (called DTTB reproduction yes-or-no process) depending on if the mobile phone 2 has the residual battery power enough for the DTTB reproduction (S209).

FIG. 9 is a flow chart to show an order of the DTTB reproduction yes-or-no process. At first, the calculation member 132 obtains the minimum voice call time stored in the memory 15 at S109 in FIG. 6 (S301). The calculation member 132 obtains the present value of the residual battery power that the residual power monitor 131 has obtained at S203 in FIG. 8 (S303). On this occasion, the calculation member 132 may obtain the present value of the residual battery power from the power supply 12.

The calculation member 132 calculates time available for processing a voice call (called available voice call time) (S305). The available voice call time may be calculated by, e.g., dividing the present value of the residual battery power obtained at S303 by a divisor, i.e., a value of battery power necessary to process a voice call for a unit of time. The divisor may be variable depending on condition such as a distance from a base station. A value of battery power used for processing a voice call for the available voice call time calculated at S305 is called residual voice call battery power.

The calculation member 132 calculates time available for the DTTB reproduction (called available reproduction time) (S307). The available reproduction time may be calculated, e.g., on the basis of subtracting the minimum voice call time obtained at S301 from the present value of the residual battery power obtained at S303.

Comparing the available voice call time calculated at S305 with the minimum voice call time defined at S109 in FIG. 6, the calculation member 132 determines if the available voice call time exceeds the minimum voice call time (S309).

If the available voice call time exceeds the minimum voice call time (“YES” of S309), the calculation member 132 determines that the DTTB reproduction is possible and informs the residual power monitor 131 that the DTTB reproduction is possible (S311).

If the available voice call time is less than the minimum voice call time (“NO” of S309), the calculation member 132 determines that the DTTB reproduction is not possible and informs the residual power monitor 131 that the DTTB reproduction is not possible (S313).

The residual power monitor 131 determines if the DTTB reproduction is possible according to what is informed by the calculation member 132 at S311 or S313.

If the calculation member 132 informs the residual power monitor 131 that the DTTB reproduction is possible (“YES” of S211), the mobile phone 2 receives and reproduces a DTTB program as it is determined that the DTTB reproduction is possible (S213).

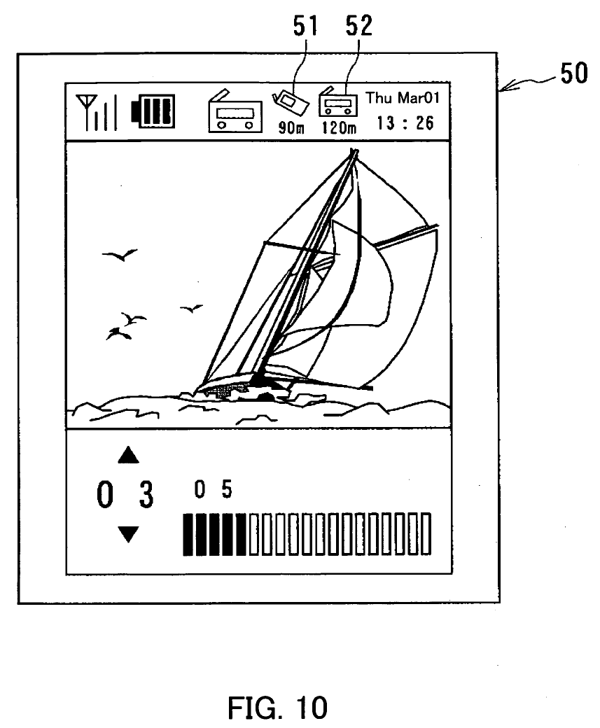

FIG. 10 is an exemplary diagram to show a reproduced picture 50 seen on the liquid crystal display 22 if the mobile phone 2 receives and reproduces a DTTB program. The reproduced picture 50 includes an available voice call time indicator 51 indicating the available voice call time and an available reproduction time indicator 52 indicating the available reproduction time.

In FIG. 10, the available voice call time indicator 51 and the available reproduction time indicator 52 indicate “90 m” as the available voice call time and “120 m” as the available reproduction time, respectively. These indicators 51 and 52 say that the available voice call time and the available reproduction time are 90 minutes and 120 minutes, respectively.

The main controller 11 lets the available reproduction time indicator 52 indicate the available reproduction time that the calculation member 132 has calculated at S307 (S215). The main controller 11 lets the available voice call time indicator 51 indicate the available voice call time that the calculation member 132 has calculated at S305 (S217).

Being informed that the DTTB reproduction is not possible by the calculation member 132 (“NO” of S211), or if the present value of the residual battery power is less than the regular value of the residual battery power (“NO” of S207), the residual power monitor 131 tells the main controller 11 to raise an alarm. The main controller 11 displays an alarm on the liquid crystal display 22 (S219). On this occasion, the mobile phone 2 may raise the alarm by vibration or rumbling so as to draw attention of the user.

After raising the alarm, the main controller 11 encourages the user to select to start the DTTB reproduction or not (S221). If the user selects to start the DTTB reproduction (“YES” of S221), the main controller 11 receives and reproduces a DTTB program (S213). The main controller 11 indicates the available reproduction time that the calculation member 132 has calculated at S307 (S215). The main controller 11 indicates the available voice call time that the calculation member 132 has calculated at S305 (S217).

If the user does not select to start the DTTB reproduction (“NO” of S221), the main controller 11 ends the process without receiving and reproducing the DTTB program. At S221, the main controller 11 may forbid receiving and reproducing the DTTB program and directly end the process without encouraging the user to select if the DTTB reproduction should be started.

Before starting a process of the DTTB reproduction, as described above, the mobile phone 2 may determine if the DTTB reproduction is possible by calculating the available reproduction time taking the residual battery power necessary to process a voice call for the minimum voice call time into account. Having determined that the DTTB reproduction is not possible, the mobile phone 2 raises an alarm to the user.

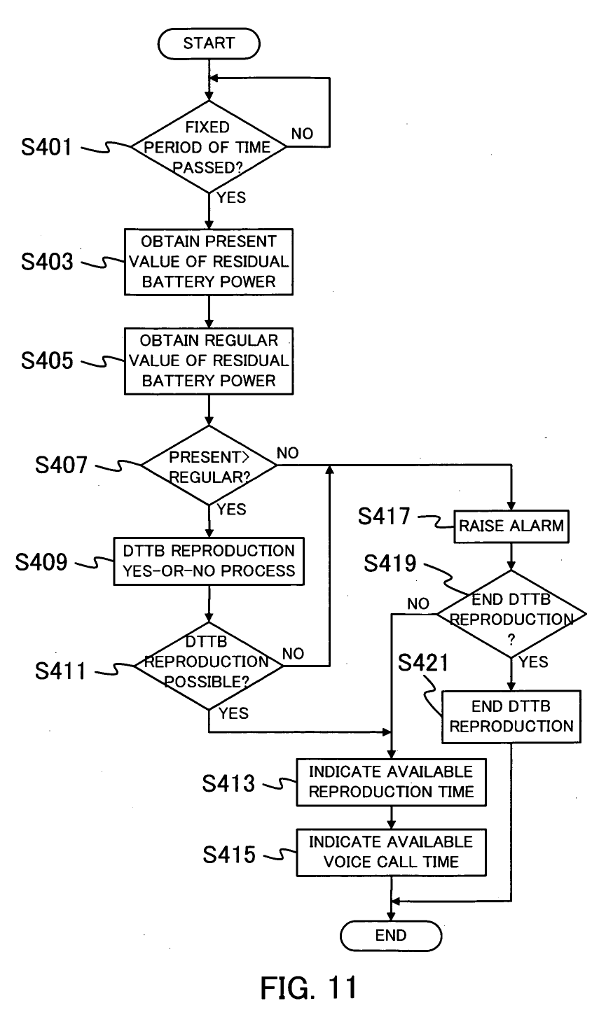

While receiving and reproducing a DTTB program, the mobile phone 2 may perform a process for monitoring the residual battery power. An order of the process for monitoring the residual battery power will be described with reference to FIG. 11.

While the mobile phone 2 receives and reproduces a DTTB program, the residual power monitor 131 determines if a fixed period of time (e.g., 60 seconds) has passed (S401). The fixed period of time may be stored in the memory 15 in advance or may be entered by the user through the operation keys 21. Before the fixed period of time passes (“NO” of S401), the residual power monitor 131 waits until the fixed period of time passes.

After the fixed period of time has passed (“YES” of S401), the residual power monitor 131 obtains a present value of the residual battery power from the power supply 12 (S403), and the regular value of the residual battery power from the memory 15 (S405).

The residual power monitor 131 determines if the present value of the residual battery power exceeds the regular value of the residual battery power (S407). If the present value of the residual battery power exceeds the regular value of the residual battery power (“YES” of S407), the calculation member 132 performs the DTTB reproduction yes-or-no process from S301 to S311 (or S313) which has been earlier described and explanation of which is omitted.

The residual power monitor 131 determines if the DTTB reproduction is possible or not according to what is informed by the calculation member 132, i.e., the DTTB reproduction is possible or not possible as S211 (S411).

If the calculation member 132 informs the residual power monitor 131 that the DTTB reproduction is possible (“YES” of S411), the main controller 11 continues the DTTB reproduction as it is determined that the DTTB reproduction is possible. The main controller 11 lets the available reproduction time indicator 52 of the reproduced picture 50 indicate the available reproduction time that the calculation member 132 has calculated at S307 (S413). The main controller 11 lets the available voice call time indicator 51 of the reproduced picture 50 indicate the available voice call time that the calculation member 132 has calculated at S 305 (S415).

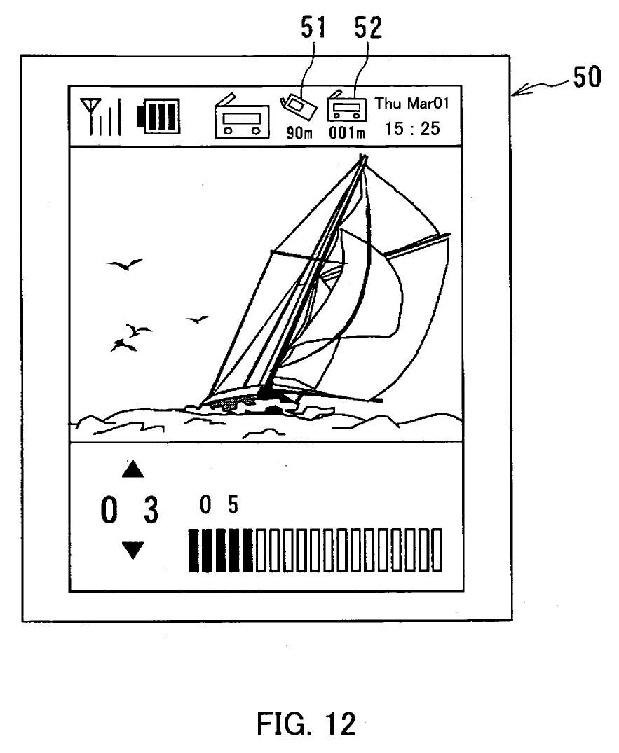

FIG. 12 is another exemplary diagram to show the reproduced picture 50 seen on the liquid crystal display 22 while the mobile phone 2 is receiving and reproducing a DTTB program. In FIG. 12, the available voice call time indicator 51 and the available reproduction time indicator 52 indicate “90 m” as the available voice call time and “001 m” as the available reproduction time, respectively. By seeing these indicators 51 and 52, the user may recognize that the available voice call time and the available reproduction time are 90 minutes and one minute, respectively.

The available reproduction time indicator 52 indicates that the available reproduction time is 120 minutes after the mobile phone 2 starts the DTTB reproduction process at a point of time shown in FIG. 10. As the residual battery power decreases by the DTTB reproduction process, the available reproduction time indicator 52 indicates that the available reproduction time is reduced to one minute at a point of time shown in FIG. 12.

Being informed that the DTTB reproduction is not possible (“NO” of S411), or if the present value of the residual battery power is less than the regular value of the residual battery power (“NO” of S407), the residual power monitor 131 tells the main controller 11 to raise an alarm. The main controller 11 displays an alarm on the liquid crystal display 22 (S417). On this occasion, the mobile phone 2 may raise the alarm by vibration or rumbling so as to draw attention of the user. The mobile phone 2 may draw attention of the user by changing a color of the available reproduction time indicator 52 or blinking the available reproduction time indicator 52/

After raising the alarm, the main controller 11 encourages the user to select to end the DTTB reproduction or not (S419). If the user does not select to end the DTTB reproduction (“NO” of S419), the main controller 11 continuously receives and reproduces the DTTB program (S213). The main controller 11 indicates the available reproduction time that the calculation member 132 has calculated at S307 (S413). The main controller 11 indicates the available voice call time that the calculation member 132 has calculated at S305 (S415).

If the user selects to end the DTTB reproduction (“YES” of S419), the main controller 11 ends receiving and reproducing the DTTB program (S421). At S419, the main controller 11 may forbid receiving and reproducing the DTTB program and directly end the process without encouraging the user to select to continue the DTTB reproduction or not.

The mobile phone 2 may determine if the DTTB reproduction is possible or not by calculating the available reproduction time taking battery power assigned to voice communication for a fixed period of time into account. Having determined that the DTTB reproduction is not possible, the mobile phone 2 raises an alarm to the user.

As described above, the mobile phone 2 of the second embodiment calculates the available reproduction time on the basis of the residual reproduction battery power, i.e., the residual voice call battery power subtracted from the total residual battery power. The mobile phone 2 does not necessarily do so, but may calculate and display the available reproduction time on the basis of the total residual battery power.

As described above, the mobile phone 2 of the second embodiment assures the residual voice call battery power. The mobile phone 2 does not necessarily do so, but may assure battery power for various applications such as playing music, games or wireless local area networks (WLAN).

The mobile phone 2 may raise an alarm at S219 by indicating numerals and an icon of the available reproduction time indicator 52 which are larger than usual, or by scrolling the available voice call time indicator 51 and the available reproduction time indicator 52 like running a telop. Such scrolling may be effective for avoiding burn-in of the liquid crystal display 22. The mobile phone 2 may usually skip the steps S215, S217, S413 and S415, but may follow these steps only in a case where the residual battery power or the residual reproduction battery power is no greater than a fixed value.

If being connected with an earphone, the mobile phone 2 may raise an alarm at S219 by producing an alarm sound through the earphone.

While receiving a moving picture signal such as of DTTB and reproducing a moving picture, the mobile phone 2 of the present invention may always assure battery power required for voice call processing by monitoring the residual battery power taking battery power required for voice call processing for a fixed period of time into account.

The mobile phone 2 of the present invention may enable the user to arrange time assigned to the DTTB reproduction recognizing the residual battery power by calculating and indicating both the available voice call time and the available reproduction time on the basis of the residual battery power.

The present invention is not necessarily limited to the mobile phone 2 of the second embodiment described above, but may be applied to any kind of data processing devices capable of reproducing TV programs including DTTB, such as personal handy phone system (PHS), a personal digital assistant (PDA), a portable moving picture player or a personal computer.

In the above description with reference to the flow charts of the second embodiment of the present invention, it is assumed that each of the steps is sequentially processed in order as shown in the flow charts. These steps are, however, not necessarily sequentially processed but may be processed in parallel or individually.

The particular hardware or software implementation of the present invention may be varied while still remaining within the scope of the present invention. It is therefore to be understood that within the scope of the appended claims and their equivalents, the invention may be practiced otherwise than as specifically described herein.

What is claimed is:

1. A mobile communication device configured to communicate by radio with a base station connected to a network, comprising:
a broadcast receiver configured to receive broadcasting;
a monitor configured to monitor condition of receiving broadcasting; and
a controller connected to the broadcast receiver and the monitor,
the controller configured to perform a first process in the foreground,
the controller configured to selectively perform a second process in the background in parallel with the first process, the second process including a process of receiving broadcasting, and the controller configured to end the process of receiving broadcasting upon the broadcast receiver receiving broadcasting as the second process as controlled by the controller and the monitor detecting degradation of the condition of receiving broadcasting.

2. The mobile communication device of claim 1, wherein the controller is further configured to end the process of receiving broadcasting if the monitor continuously detects the degradation for no less than a preset period of time.

3. The mobile communication device of claim 1 further comprising user controls configured to be manually operated, wherein the controller is further configured to end the process of receiving broadcasting if the monitor detects the degradation without manual operation to the user controls for no less than a preset period of time.

4. The mobile communication device of claim 1 further comprising a memory device, wherein the controller is further configured to record in the memory device a plurality of broadcasting data received by the broadcast receiver, and the controller is further configured to end the process of receiving broadcasting if the monitor detects the degradation while suspending recording the broadcasting data.

5. The mobile communication device of claim 1, wherein the monitor is further configured to detect information periodically carried by a broadcasting signal, and the monitor is configured to monitor the condition of receiving broadcasting on the basis of detection of the information.

6. A mobile communication device configured to be used for voice communication, configured to reproduce a moving picture, and configured to be equipped with a battery, comprising:
a calculation member configured to calculate residual battery power necessary for a process of reproduction of the moving picture on the basis of total residual battery power and residual battery power necessary for a process of voice communication;
a residual power monitor configured to determine if the reproduction is possible or not on the basis of the residual battery power calculated by the calculation member; and
a controller configured to raise an alarm upon the residual power monitor determining that the reproduction is not possible.

7. The mobile communication device of claim 6 further comprising a display, wherein the calculation member is further configured to calculate time available for the reproduction on the basis of the residual battery power necessary for the reproduction, and the controller is further configured to indicate the calculated time on the display.

8. The mobile communication device of claim 6 further comprising a display, wherein the calculation member is further configured to calculate time available for the reproduction on the basis of the residual battery power necessary for the reproduction and time available for the voice communication, and the controller is further configured to indicate on the display the calculated time available for the reproduction and the calculated time available for the voice communication.

9. The mobile communication device of claim 6, wherein the calculation member is further configured to calculate residual battery power necessary for the voice communication on the basis of a period of time of the voice communication entered into the mobile communication device.

10. The mobile communication device of claim 6, wherein the controller is further configured to forbid the reproduction upon the residual power monitor determining that the reproduction is not possible.
